(19) United States
(12) Patent Application Publication
(10) Pub. No.: US 2014/0136396 A1
(43) Pub. Date: May 15, 2014

(54) CHARACTERIZING AN INDIVIDUAL USING INFORMATION FROM A SOCIAL NETWORK

(71) Applicants: Eric Kowalchyk, Mountain View, CA (US); Mui Anne Chang, Mountain View, CA (US); Vikram Rangnekar, Mountain View, CA (US)

(72) Inventors: Eric Kowalchyk, Mountain View, CA (US); Mui Anne Chang, Mountain View, CA (US); Vikram Rangnekar, Mountain View, CA (US)

(21) Appl. No.: 13/676,334

(22) Filed: Nov. 14, 2012

(51) Int. Cl. G06Q 40/02

(52) U.S. Cl. CPC G06Q 40/025
USPC 705/38

(57) ABSTRACT

Systems and methods for characterizing an individual using social network information are described. In some examples, the systems and methods receive a request to characterize an individual, obtain social network information associated with the individual, characterize the individual, and provide an indication of the characterization to the requestor.

### TECHNICAL FIELD

The present disclosure generally relates to characterization services. More specifically, the present disclosure relates to methods, systems and computer program products for characterizing an individual using information from a social network.

### BACKGROUND

When applying for a loan, credit card, or other similar financial or other products, a person is often required to provide information establishing their worthiness. This information may be information that provides an indication of their credit or financial history, such as a credit score, information that provides an indication of their character, such as background check or reference information, or other information that supports the person in the application. In many cases, such information does not provide an accurate picture of the person. For example, the information may not reflect the person as he/she currently is and/or may provide insignificant or irrelevant details, among other things. Therefore, relying on the current process of supporting the worthiness of a person may lead to an erroneous determination of the worthiness of a person, among other drawbacks.

### DESCRIPTION OF THE DRAWINGS

Some embodiments of the technology are illustrated by way of example and not limitation in the figures of the accompanying drawings, in which:

FIG. 1 is a block diagram illustrating an example of a network environment including a server operating a system for characterizing an individual using information from a social network, consistent with some embodiments.

FIG. 2 is a block diagram illustrating modules of a characterization system, consistent with some embodiments.

FIG. 3 is a flow diagram illustrating an example method for providing a characterization of an individual to a requesting system, consistent with some embodiments.

FIG. 4 is a block diagram of a machine in the form of a computing device within which a set of instructions, for causing the machine to perform any one or more of the methodologies discussed herein, may be executed.

### DETAILED DESCRIPTION

### Overview

The present disclosure describes methods, systems, and computer program products, which individually provide functionality for characterizing an individual using information from a social network. In some examples, the systems and methods enable a requesting system, such as an approval system at a financial institution website, to obtain characterization information for an individual before approving the individual use of products or services provided by the requesting system.

In some examples, a social network service may include, or engage, a characterization system that is configured to receive a request to characterize an individual, obtain profile information associated with the individual, characterize the individual, and provide an indication of the characterization to the requestor.

As an example, a person clicks on a new credit card offer advertised to his mobile phone. The website promoting the credit card asks for the person to sign in using his social network credentials. Once logged in, an approval system at the website sends a request to the social network to characterize the credit worthiness of the person. The social network service identifies information about the person that indicates the person has a management position at a large company, and provides an indication to the approval system that the person has high credit worthiness. Using the provided indication, the approval system approves the person for an exclusive credit card provided by the website.

Thus, in some examples, a characterization system may leverage information stored by a social network, such as an online professional network, when providing information associated with an individual that may assist in verifying, validating, authorizing, and/or approving the individual at a requesting system, such as at a financial institution, among other things. The characterization system may, therefore, provide insight to a requesting system about the individual, enabling the requesting system to determine whether the individual is credit or character worthy, among other benefits.

In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

Other advantages and aspects of the inventive subject matter will be readily apparent from the description of the figures that follows.

### Suitable System

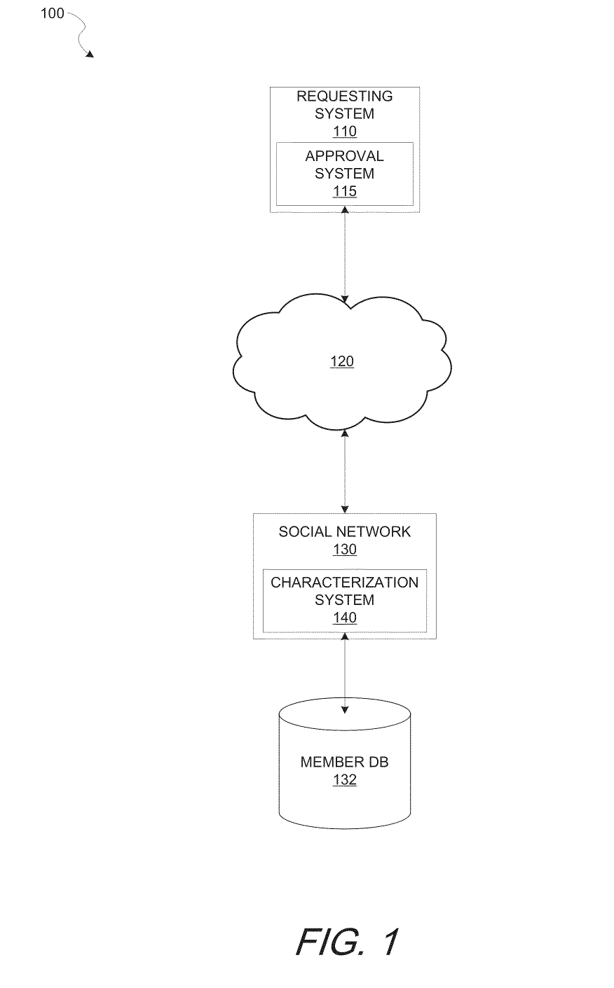

FIG. 1 is a block diagram illustrating an example of a network environment 100 including a server operating a system for characterizing an individual using information from a social network, consistent with some embodiments. The network environment 100 includes a requesting system 110, which accesses a social network service 130 over a network 120. The social network service 130 may be a professional social network or any social network that includes members, where a member is connected to, friends with, or otherwise affiliated with some of the other members of the network. The social network service 130 may include a characterization system 140 that includes systems and performs methods for characterizing individuals based on information stored at the social network, among other things.

In some examples, the requesting system 110 may be associated with, or part of, a financial institution or other entity that provides financial instruments and products, such as loans, credit cards, and so on, to individuals. In some examples, the requesting system 110 may be associated with other entities that assume risk when providing services and/or products to individuals applying for the services and/or products. Some example entities include entities that receive applications for employment, entities that receive applications for other financial instruments, entities that receive applications for memberships, and so on.

In some examples, the requesting system 110 may include an approval system 115 that receive applications and requests from individuals, and determines whether to approve or deny the received applications. The approval system 115 may obtain information from the social network 130 in order to assist in the determination of received applications, among other things.

The social network service 130 may contain, store, or have access to various types of information, such as information 132 associated with the members of the network, information associated with companies that have a presence within the social network (e.g., post listings for available jobs), and so on.

In various example embodiments, one or more portions of the network 120 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, any other type of network, or a combination of two or more such networks. The user device 110 may be any suitable computing device, such as a smart phone, a tablet, a laptop, gaming device, and/or any mobile device or computing device configured to display job listings and receive selections from users of objects displayed by webpages, emails, and/or apps.

A social network, such as the social network service 130, is a useful place in which to obtain various types of information associated with its members. Often, a social network or other similar site, such as Linkedln, Facebook, Google+, Twitter, and so on, stores various types of information or attributes associated with members of the site. For example, a friend-based social networking site may store interest information for a member (e.g., information about things a member “likes”), whereas a business-based or professional social networking site may store accomplishment, experience, and/or professional information for a member (e.g., educational or work experience information). Additionally, the social network service 130 may store a variety of information associated with a member's social graph, such as information identifying other members within the member's social graph.

Thus, in some examples, the approval system 115 of the requesting system 110 may receive an application from an individual for a product or service (e.g., a credit card or loan product) provided by the requesting system 110, obtain information that characterizes the individual from the social network service 130, and determine whether to approve the application based at least in part on the obtained information.

### Characterizing Individuals Using Social Network Information

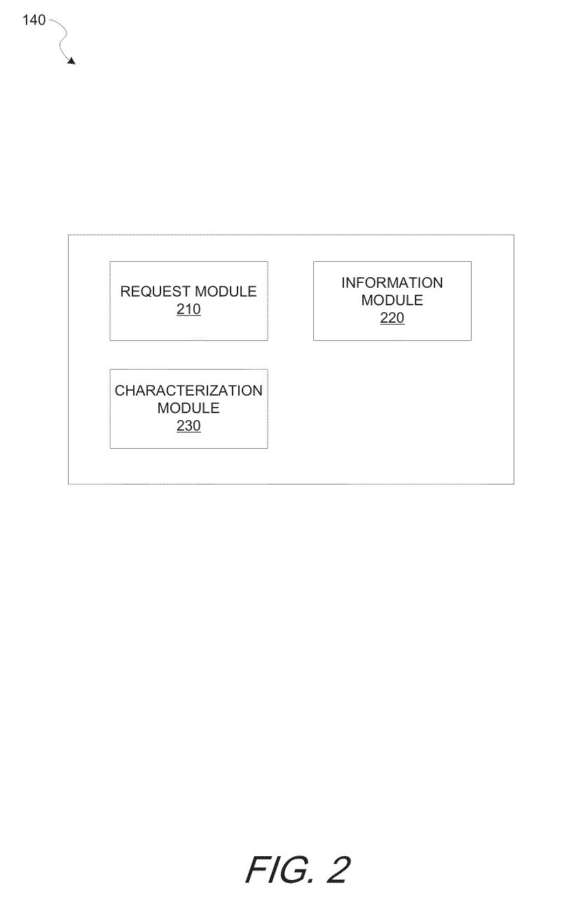

As described herein, in some example embodiments, the characterization system 140 utilizes various types of data or other information stored by a social network in order to characterize an individual, and provide the characterization to a requesting system. FIG. 2 is a block diagram illustrating modules of a characterization system 140, consistent with some embodiments.

As illustrated in FIG. 2, the characterization system 140 includes a variety of functional modules, such as a request module 210, an information module 220, and a characterization module 230. One skilled in the art will appreciate that the functional modules are implemented with a combination of software (e.g., executable instructions, or computer code) and hardware (e.g., at least a memory and processor). Accordingly, as used herein, in some embodiments a module is a processor-implemented module and represents a computing device having a processor that is at least temporarily configured and/or programmed by executable instructions stored in memory to perform one or more of the particular functions that are described herein.

In some examples, the request module 210 is configured and/or programmed to receive and process a request from a requesting system, such as a request to provide characterization information about an individual. For example, the request module 210 may receive a request from an approval system 115 to provide information about an individual that characterizes the credit worthiness and/or quality of character of the individual.

The request module 210 may parse or otherwise identify within a received request certain information about the individual to be provided to the requesting system. The request module 210 may identify a type of information associated with the individual to be provided to the requesting system, a type of characterization metric associated with the individual to be provided to the requesting system, and so on.

In some examples, the information module 220 is configured and/or programmed to identify and/or obtain information associated with the individual from a social network, such as information associated with the individual from a social network that includes the individual as a member. For example, the information module 220 may identify and/or obtain information from the member database 132 associated with the social network 130.

Example data and/or information that may be obtained by the information module 220 may include:

Profile information, such as information associated with a member's educational background (e.g., school information, degree information, grade information, exam information, activity information, organization information, and so on), work or professional history (e.g., company information, job title information, job skills information, job responsibility information, length of employment information, and so on), member information (e.g., residence information, citizenship information, language information, activity and interest information, and so on), and so on; and/or

Social graph information, such as profile information associated with friends, connections, group affiliations, references, and so on, of a member; and so on.

In some examples, the characterization module 230 is configured and/or programmed to characterize the individual based on the obtained information and/or provide some or all of the obtained information to a requesting system. For example, the verification module 230 may provide information obtained via the information module 220 to the requesting system 110.

The characterization module 230, in some examples, may characterize an individual based on the obtained information in a number of ways. For example, the characterization module 230 may determine the credit worthiness of an individual based on a presence of professional information (e.g., current or previous employers, job titles, lengths of service, and so on), social graph information, or other information; and/or determine the quality of character of an individual based on the professional information, social graph information, and/or other information.

Of course, one or ordinary skill in the art will appreciate that the characterization module 230 may utilize a variety of techniques, scenarios, and/or rules-based processes when characterizing an individual based on social network information. For example, the characterization module 230 may determine an individual is credit worthy when the information associated with the individual indicates a continuous employment history or certain job title, among other things.

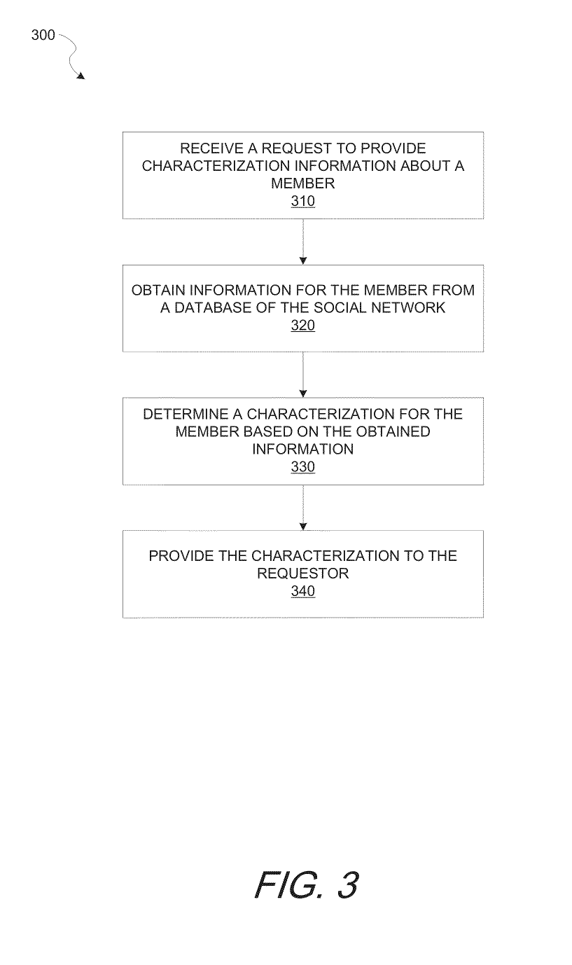

As described herein, the characterization system 140 may perform a variety of processes or methods in order to characterize an individual and provide the information to a requesting system. FIG. 3 is a flow diagram illustrating an example method 300 for characterizing an individual based on social network information, consistent with some embodiments.

In step 310, a social network receives a request to provide characterization information about an individual that is a member. For example, the request module 210 of the characterization system 140 receives a request to characterize an individual, such as an individual applying for a product or service provided by the requesting system 110.

In step 320, the social network obtains and/or identifies information associated with the individual from a social network that includes the individual as a member. For example, the information module 220 of the characterization system 140 may identify and/or obtain information from the member database 132 of the social network 130.

As described herein, the information module 220 may obtain various types of information associated with an individual, such as profile information, social graph information, and so on. The information module 220 may obtain information specifically requested by the requesting system 110. For example, the request module 210 may parse a received request, determine the request includes a request for information about the individual's current employer, and the information module 220 may obtain information from the member database 132 that is associated with the individual's current job, among other things.

In step 330, the characterization system characterizes, or determines a characterization for the individual based on the social network information. For example, the characterization module 230 of the characterization system 140 may assign a certain attribute to the individual that is associated with a credit worthiness or quality of character of the individual.

In some examples, the characterization module 230 may calculate or otherwise determine a characterization or worthiness score for the individual based on the information associated with the individual, and transmit the determined score to the requesting system. The determined score may indicate an individual is worthy or otherwise qualified (or, pre-qualified), or may indicate a level of worthiness for the individual, among other things.

For example, the characterization module 230 may follow the following rules-based or condition-based processes when characterizing an individual based on social network information:

| Condition | Characterization |
|---|---|
| Presence of current employer over a | Individual is qualified |
| certain period of time | |
| Presence of consistent work history | Individual is qualified |
| over a certain period of time | |
| Certain number of connections share an | Individual is qualified |
| employer name | |
| No current employer | Individual is not-qualified |
| Inconsistent work history | Individual is not-qualified |
| Current employer is an unknown entity | Individual is possibly qualified |

Of course, one or ordinary skill in the art will realize that the characterization module 230 may utilize other rules/conditions and/or characterizations.

In step 340, the social network provides an indication of the characterization to the requestor. As described herein, the social network 130 may transmit the information directly (e.g., via various APIs, direct messaging protocols, and so on) to the requesting system 110 may transmit the information (e.g., via email, instant messaging, text messaging, and so on).

As described herein, in some examples, the requesting system 110 may utilize information provided by the characterization system 140 when determining whether to approve use of products or services for the individual, among other things. Thus, in some examples, a requesting system 110, such as a financial institution may utilize social network information associated with individuals to determine whether the individuals are qualified to use the services and products provided by the system.

### CONCLUSION

The various operations of example methods described herein may be performed, at least partially, by one or more processors that are temporarily configured (e.g., by software) or permanently configured to perform the relevant operations. Whether temporarily or permanently configured, such processors may constitute processor-implemented modules, engines, objects or devices that operate to perform one or more operations or functions. The modules, engines, objects and devices referred to herein may, in some example embodiments, comprise processor-implemented modules, engines, objects and/or devices.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

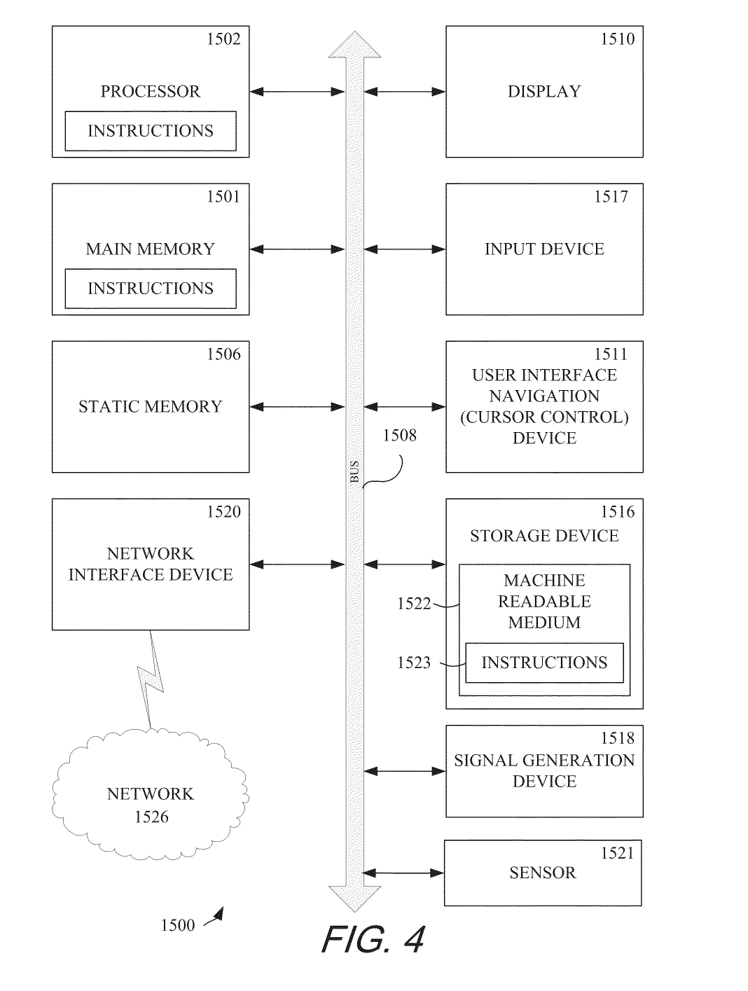

FIG. 4 is a block diagram of a machine in the form of a computer system or computing device within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. In some embodiments, the machine will be a desktop computer, or server computer, however, in alternative embodiments, the machine may be a tablet computer, a mobile phone, a personal digital assistant, a personal audio or video player, a global positioning device, a set-top box, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A method, comprising:
receiving a request from an approval system associated with a financial institution to provide information associated with a member of a social network service;
obtaining profile information associated with the member of the social network service;
characterizing, using a processor, the member based on the obtained profile information by determining a characterization score based on the obtained profile information; and
providing the characterization score to the approval system in response to the received request.

2. The method of claim 1, wherein characterizing the member based on the obtained profile information includes determining a financial worthiness for the member based on the obtained profile information.

3. The method of claim 1, wherein characterizing the member based on the obtained profile information includes assigning a financial attribute to the member based on the obtained profile information.

4. The method of claim 1, wherein characterizing the member based on the obtained profile information includes assigning a character attribute to the member based on the obtained profile information.

5. The method of claim 1, wherein obtaining profile information associated with a member of a social network service includes obtaining professional information from a professional social network of which the member is affiliated.

6. The method of claim 1, wherein the approval system is associated with a financial institution, and wherein characterizing the member based on the obtained profile information includes determining a credit worthiness for the member based on the obtained profile information.

7. A system, comprising:
a memory and at least one processor;
a request module configured to receive a request from an approval system associated with a financial institution to provide information associated with a member of a social network service;
an information module configured to obtain profile information associated with the member of the social network service;
a characterization module, executable by the memory and the at least one processor, configured to characterize the individual based on the obtained information by determining a characterization score based on the obtained profile information; and
the characterization module further configured to provide the characterization score to the approval system in response to the received request.

8. The system of claim 7, wherein the characterization module is configured to determine a financial worthiness for the individual based on the obtained information.

9. The system of claim 7, wherein the characterization module is configured to assign a financial attribute to the individual based on the obtained information.

10. The system of claim 7, wherein the characterization module is configured to assign a character attribute to the individual based on the obtained information.

11. The system of claim 7, wherein the information module is configured to obtain professional information from a professional social network of which the individual is a member.

12. (canceled)

13-20. (canceled)

21. The method of claim 1, further comprising:
identifying a type of information from the request from the approval system; and
obtaining profile information associated with the member of the social network service based on the identified type of information.

22. The method of claim 1, further comprising:
identifying a type of score from the request from the approval system, the characterization score corresponding to the identified type of score.

23. The method of claim 1, wherein the characterizing the member includes using a time period condition in conjunction with the obtained profile information.

24. The method of claim 1, wherein the request from the approval system includes a specification of information to obtain in association with the member.

25. The method of claim 1, wherein providing the characterization score to the approval system includes providing the obtained profile information.

26. The system of claim 7, further comprising:
the request module further configured to identify a type of information from the request from the approval system; and
the information module further configured to obtain profile information associated with the member of the social network service based on the identified type of information.

27. The system of claim 7, further comprising:
the request module further configured to identify a type of score from the request from the approval system, the characterization score corresponding to the identified type of score.

28. The system of claim 7, wherein the characterizing the member includes using a time period condition in conjunction with the obtained profile information.

29. The system of claim 7, wherein the request from the approval system includes a specification of information to obtain in association with the member.
